(19) United States
(12) Patent Application Publication
(10) Pub. No.: US 2026/0152072 A1
(43) Pub. Date: Jun. 4, 2026

(54) SYSTEM FOR PROTECTING AGAINST SHORT-CIRCUITS

(71) Applicants: SAFRAN ELECTRICAL & POWER, Blagnac Cedex (FR); PYROALLIANCE, Les Mureaux (FR)

(72) Inventors: Jerome VALIRE, Moissy-Cramayel (FR); Ludovic GUYOT, Moissy-Cramayel (FR); Sebastien THOMASSIER, Moissy-Cramayel (FR); Frederic MIRALLES, Les Mureaux (FR); Cedric LEFUEL, Les Mureaux (FR); Christian FORYS, Les Mureaux (FR)

(21) Appl. No.: 18/704,721

(22) PCT Filed: Nov. 2, 2022
(86) PCT No.: PCT/FR2022/052061

§ 371 Date: Apr. 25, 2024

(30) Foreign Application Priority Data
Nov. 5, 2021 (FR) 2111762

(51) Int. Cl. B60L 3/00; H01H 9/10; H01H 39/00; H01H 85/38; H01H 85/42

(52) U.S. Cl. CPC B60L 3/0061; H01H 9/10; H01H 39/00; H01H 85/42; B60L 2200/10; H01H 2085/388

(57) ABSTRACT

A system for protecting against a short circuit, including a main branch and a secondary branch having a fuse, the system including a pyrotechnic actuator having a gas generator and a piston movable between an initial position and a final position, the system being configured to occupy the following positions: a passive position; and an active position, wherein the secondary branch includes a movable slide which is rigidly connected to one end of the fuse and is capable of being translated by the piston when the system moves from its passive position to its active position, the system being configured so that the slide causes the fuse to break after the main branch has opened when the system moves from its passive position to its active position.

### TECHNICAL FIELD OF THE INVENTION

The present invention relates to a system for protecting against the short-circuits in a high-voltage direct-current electrical circuit.

### TECHNICAL BACKGROUND

A hybrid electric or all-electric aircraft is propelled by one or more electric thrusters, each comprising, for example, a propeller driven by an electric motor.

Depending on the different phases of flight, each electric motor can be supplied with electricity via a turbo-generator and/or batteries, for example.

A turbo-generator comprises a turboshaft engine and at least one electric generator, the electric generator transforming the mechanical power generated by the turboshaft engine into an electrical power intended for supplying the thrusters or for being stored within the batteries.

The electric thruster or thrusters are integrated into a High Voltage Direct Current (HVDC) electrical circuit which is protected against the short circuits by at least one protection system, the protection system allowing the circuit to be opened and de-energised when a short-circuit current is detected.

By definition, a short-circuit is dangerous and liable to cause incidents of varying degrees of seriousness, which is why the short-circuit protection systems are essential in an aircraft to guarantee the safety of the passengers.

A known protection system comprises a main branch and a secondary branch connected in parallel. The secondary branch has a higher impedance than the main branch and comprises a fuse rated for a high short-circuit current. More specifically, the fuse is designed to withstand high currents over a sufficiently long period. The fuse is designed to open the secondary branch by melting one or more of its elements when a short-circuit current of sufficient intensity passes through it to melt it. The system also comprises an actuator configured to open the main branch irreversibly when a high short-circuit current is detected, and to force the short-circuit current to pass through the secondary branch and more particularly the fuse, to permanently de-energise the circuit.

Such a system is designed to protect the circuit against the high intensity short-circuit currents, which are generally the most dangerous in the short term. The fuse in the secondary branch is designed to melt at currents of intensity of the order of a hundred amperes, while having a sufficiently long melting time to completely extinguish the electric arc in the main branch at currents of intensity of the order of thousands of amperes.

However, in the aeronautical sector, the passenger safety must be total, so the circuit must be de-energised as soon as a short-circuit current is detected, whatever its intensity (for example, in the order of a milliampere for an insulation fault). The short-circuit currents of low or medium intensity can also be the cause of more or less serious incidents in the short and/or long term.

The aim of the present invention is therefore to provide a system for protecting against a short-circuit in a high-voltage direct-current electrical circuit which ensures that the main and secondary branches are open, whatever the intensity of the short-circuit current.

The prior art also comprises the documents WO2020/204154A1, WO2020/054580A1 and U.S. Pat. No. 3,274,363A.

### SUMMARY OF THE INVENTION

The invention thus proposes a system for protecting against a short-circuit for a high-voltage direct-current electrical circuit, the system comprising a main branch and a secondary branch connected in parallel and adapted to be connected to the electrical circuit via two common input and output terminals, the secondary branch comprising a fuse and having an impedance greater than that of the main branch, the system comprising a pyrotechnic actuator comprising a gas generator and a piston movable between an initial position and a final position, said system being configured to occupy the following positions:
a passive position in which the piston is in its initial position, the main and secondary branches being closed;
an active position in which the piston is placed in its final position under the action of gas generated by said generator when a short-circuit current is detected, the main branch being opened under the action of the piston;
   the secondary branch comprising a movable slide which is secured to one end of the fuse and able to be driven in translation under the action of the piston when the system moves from its passive position to its active position, the system being configured so that the slide causes the fuse to break after the main branch has opened when the system moves from its passive position to its active position, so as to ensure that the secondary branch opens regardless of the intensity of the short-circuit current;
characterised in that the main branch comprises a first electrical contact between a fixed member and a first flexible tab, the system comprising a first separator which is mobile in translation and secured to the piston, the first separator being configured to be interposed between the fixed member and the first flexible tab when the system is in its active position, so as to open the first electrical contact and consequently the main branch.

By introducing a slide into the secondary branch, which causes the fuse to break under the action of the piston, it is possible to open the secondary branch (and therefore to open the system and the circuit) in a specific time (preferably less than 5 ms), regardless of the intensity of the short-circuit current.

Such a system is compatible for opening 800 volt DC supplied circuits in less than 5 milliseconds, when subjected to short-circuit currents ranging from 0 to 10,000 amperes, with an L/R time constant greater than 0.1 milliseconds.

The system according to the invention may comprise one or more of the following characteristics, taken alone or in combination with each other:
the slide has a first end attached to the fuse and a second end attached to a stop which is movable in translation, the first separator being able to come to bear against a bearing face of the stop in order to drive it in translation when the system passes from its passive position to its active position;
the first separator is at a distance from the bearing face of the stop when the system is in the passive position;
the main branch comprises a second electrical contact between the fixed member and a second flexible tab, the system comprising a second separator which is mobile in translation and secured to both the piston and the first separator, the second separator being parallel to the first separator, the second separator being configured to be interposed between the fixed member and the second flexible tab when the system is in its active position, so as to open the first and second electrical contacts and consequently the main branch;
the fixed member is interposed between the first and second separators on the one hand and between the first and second tabs on the other hand, the first and second tabs being respectively in contact with the upper face and the lower face of the fixed member when the system is in the passive position;
the first and second separators each have a chamfer configured to facilitate the opening of the first and second electrical contacts;
the first and second tabs are symmetrical and meet at the level of a common base which is connected to the common output terminal, each of the first and second tabs comprising a convex section and a concave section in contact with the fixed member when the system is in the passive position;
each of the first and second separators is guided in translation between a structure of the system and the fixed member;
the main and secondary branches are horizontally next to each other, the actuator being vertically above the first and second separators and the main branch;
the first and second separators are secured to the piston via a connecting element, the first and second separators and the piston being movable in translation in the same direction of movement when the system moves from a passive position to an active position;
the first and second separators are secured to the piston via a lever articulated with respect to a structure of the system, the first and second separators being movable in translation in a direction of movement which is opposite to that of the piston, when the system passes from a passive position to an active position;
the actuator comprises a rod having a first end attached to the piston and a second end carrying a first pin inserted in a first oblong hole of the lever, the system comprising a connecting element having a first end secured to the first and second separators and a second end carrying a second pin inserted in a second oblong hole of the lever, the lever being articulated between the first and second oblong holes.

The present invention also relates to an electrical circuit comprising at least one electric thruster and a system for protecting against a short-circuit as described above.

The present invention also relates to an aircraft comprising an electrical circuit as described above.

### BRIEF DESCRIPTION OF THE FIGURES

The invention will be better understood and other details, characteristics and advantages of the present invention will become clearer from the following description made by way of non-limiting example and with reference to the attached drawings, in which:

FIG. 1 is a perspective view of a short-circuit protection system according to a first embodiment of the invention;

FIG. 2 is a cross-sectional view of the system illustrated in FIG. 1 along sectional plane II-II of FIG. 1;

FIG. 3 is a cross-sectional view of the system illustrated in FIG. 1 along sectional plane III-III of FIG. 1;

FIG. 4 is a cross-section comparable to that of FIG. 2 illustrating a second embodiment of the invention.

### DETAILED DESCRIPTION OF THE INVENTION

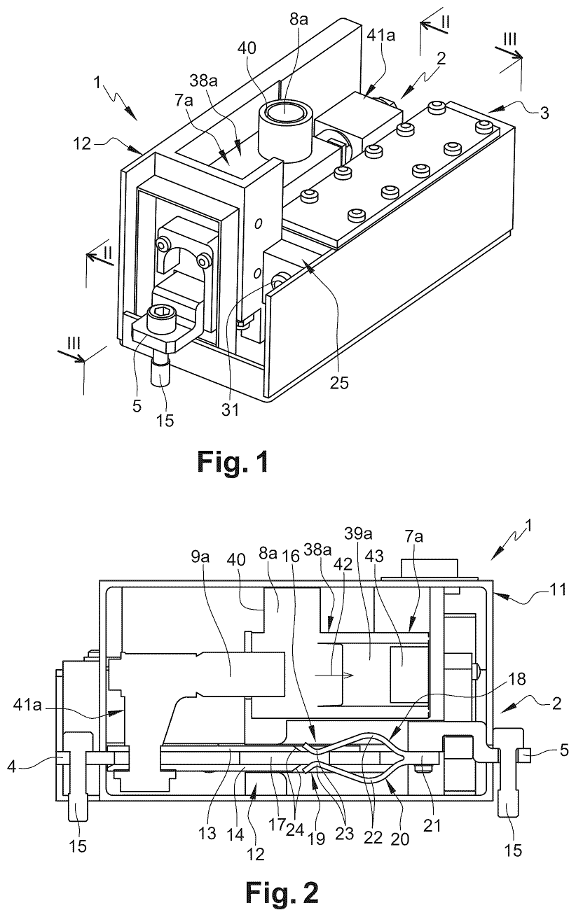

FIGS. 1 to 4 show a short-circuit protection system 1 according to the invention.

Such a system 1 is designed to be integrated into a high-voltage direct current (HVDC) electrical circuit in an aircraft.

Advantageously, such a circuit comprises at least one electric thruster designed to propel the hybrid electric or all-electric aircraft. The electric drive is, for example, a propeller driven by an electric motor.

Such a circuit is supplied by a turbine generator and/or batteries, for example. The supply voltage is 800 volts, for example.

As illustrated in the figures, the system 1 comprises a main branch 2 and a secondary branch 3 connected in parallel. The main and secondary branches 2, 3 are connected to the electrical circuit via a common input terminal 4 and a common output terminal 5. The secondary branch 3 comprises a fuse 6. The secondary branch 3 has a higher impedance than the main branch 2. The system 1 comprises a pyrotechnic actuator 7a, 7b comprising a gas generator 8a, 8b and a piston 9a, 9b movable between an initial position and a final position.

The system 1 is configured to occupy the following positions:
a passive position in which the piston 9a, 9b is in its initial position, the main and secondary branches 2, 3 being closed;
an active position in which the piston 9a, 9b is placed in its final position under the action of gas generated by the generator 8a, 8b when a short-circuit current is detected, the main branch 2 being opened (or cut off) under the action of the piston 9a, 9b.

According to the invention, the secondary branch 3 comprises a mobile slide 10 which is secured to one end of the fuse 6 and able to be driven in translation under the action of the piston 9a, 9b when the system 1 passes from its passive position to its active position. The system 1 is configured so that the slide 10 causes the fuse 6 to break after the main branch 2 has been opened when the system 1 moves from its passive position to its active position, so as to ensure that the secondary branch 3 is opened (or cut off) regardless of the intensity of the short-circuit current.

The main branch 2 comprises a first electrical contact 16 between a fixed member 17 and a first flexible tab 18. The system 1 comprises a first separator 13 which is movable in translation and is secured to the piston 9a, 9b. The first separator 13 is configured to be interposed between the fixed member 17 and the first flexible tab 18 when the system 1 is in its active position, so as to open the first electrical contact 16 and consequently the main branch 2.

As indicated above, when the system 1 is in the passive position, the main and secondary branches 2, 3 are closed. By default, the system is in the passive position, i.e. a position in which the current can circulate in the main and secondary branches 2, 3. The system is in the passive position when the circuit is operating normally, i.e. without a short-circuit.

As indicated above, when the system 1 is in the active position, the main and secondary branches 2, 3 are open. The system switches to the active position when a short-circuit is detected in the circuit, regardless of its intensity. Switching to the active position allows to open the system and, more generally, the circuit, in particular to protect the electric thrusters and the surrounding installations.

By introducing a slide 10 into the secondary branch 3, which causes the fuse 6 to break under the action of the piston 9a, 9b, it is possible to open the secondary branch 3 (and therefore to open the system and the circuit) in a specific time (preferably less than 5 ms), whatever the intensity of the short-circuit current.

The secondary branch 3 is used to open the system 1 (and therefore the circuit) in a controlled manner when a short-circuit is detected. Opening the main branch 2 is a prerequisite for directing the short-circuit current into the secondary branch 3, and thus controlling the opening of the system 1 (and therefore the circuit).

Depending on the intensity of the short-circuit current, the fuse 6 breaks under the action of a mechanical stress (i.e. the force imposed by the slide and initiated by the piston) and/or under the action of a thermal stress (i.e. the heat linked to the passage of the short-circuit current).

So, for example, when the short-circuit current is of low intensity, the fuse breaks mainly or completely under the action of the aforementioned mechanical stress. Conversely, when the short-circuit current is of high intensity, most or all of the fuse blows as a result of the thermal stress mentioned above.

The fuse 6 is configured to interrupt an electric arc potential formed when it breaks (and thus allow the secondary branch to open). An electric arc is particularly likely to occur when the short-circuit current is of medium or high intensity. To stop a potential electric arc quickly, the fuse 6 comprises a material designed to absorb the thermal energy released when it breaks, for example silica. The silica melts under the action of the electric arc and then vitrifies to become an excellent insulator that interrupts the electric arc.

Advantageously, the system 1 also comprises at least one degassing element which is arranged close to the fuse 6 to help interrupt the electric arc.

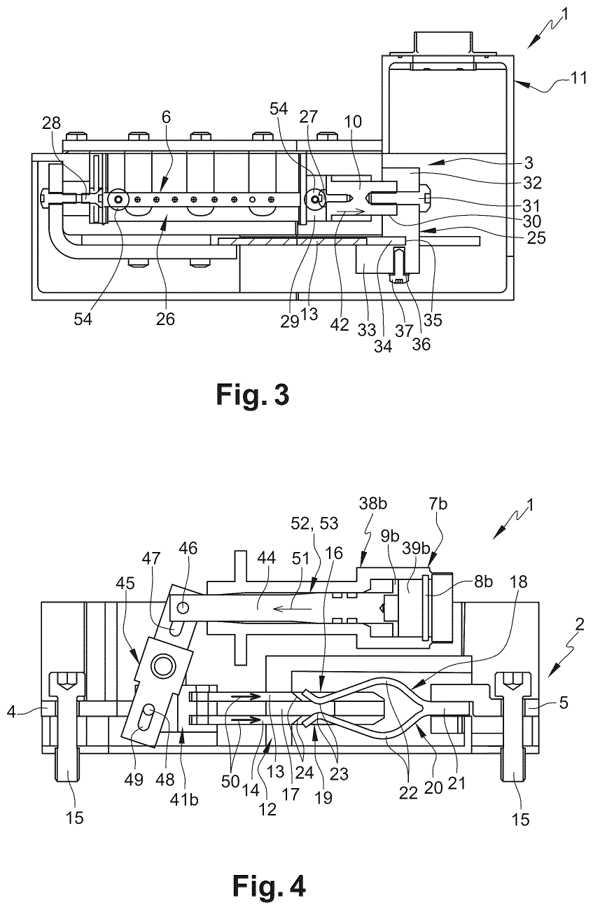

As illustrated in FIG. 3, the system 1 comprises two degassing elements 54 arranged at each end of the fuse 6, each degassing element 54 being in the form of a polymer disc which is configured to release a gas which helps to interrupt the electric arc when it is thermally subjected.

As indicated above, the fuse 6 is designed for a high intensity short-circuit current. More specifically, the fuse 6 is designed to withstand high intensity currents for a sufficiently long time to allow the main branch 2 to be opened beforehand. “High intensity current” for a short-circuit current means a current greater than 1000 amperes, for example 8000 amperes.

As indicated above, the impedance of the secondary branch 3 is higher than that of the main branch 2.

Advantageously, the current in the secondary branch 3 is at least 100 times less than that in the main branch 2, so that most of the current flows through the main branch 2 when the system 1 is in the passive position, to the benefit of the service life of the secondary branch 3 (and therefore of the system) and of the power consumption of the system 1.

The system 1 (and more particularly the actuator) is controlled by a control device, this control device being informed of the presence or absence of a short-circuit by a sensor (for example a coil sensor) which may or may not be integrated into the system 1. The control device commands the system 1 to switch to the active position as soon as a short-circuit is detected, regardless of its intensity. The intensity of the short-circuit current may be between 0 and 10,000 amperes, for example.

In the embodiments illustrated in FIGS. 1 to 4, the system 1 comprises a housing 11 (partly shown) in which the main and secondary branches and the pyrotechnic actuator 7a, 7b are integrated. The housing 11 forms an insulating, watertight chamber to protect the elements inside from the outside environment, and vice versa. The system 1 comprises a structure 12 arranged inside the housing 11 and on which the various elements of the system 1 are mounted. The structure 12 can be formed with the housing 11 or separately from the housing 11. The main and secondary branches 2, 3 are horizontally next to each other, with the actuator 7a, 7b vertically above the first and second separators 13, 14 and the main branch 2. The common input and output terminals 4, 5 (also referred to as input and output power bars) are each in the form of an electrical bar fitted with a captive screw 15 to allow it to be connected to the circuit.

As shown in the embodiments in FIGS. 1 to 4, the main branch 2 comprises a fixed member 17 and two flexible tabs 18, 20 (from the input terminal to the output terminal).

More specifically, as illustrated in FIGS. 2 and 4, the main branch 2 comprises a first electrical contact 16 between the fixed member 17 and a first flexible tab 18 and a second electrical contact 19 between the fixed member 17 and a second flexible tab 20. The first and second electrical contacts 16, 19 are closed when the system 1 is in the passive position and open when the system 1 is in the active position. The first and second contacts 16, 19 are therefore normally closed.

The fixed member 17 is interposed between the first and second tabs 18, 20. The first and second tabs 18, 20 overlap the fixed member 17 when the system 1 is in the passive position. The first and second tabs 18, 20 are respectively in contact with the upper face and the lower face of the fixed member 17 when the system 1 is in the passive position. In this case, the fixed member 17 is integrally formed with the input terminal 4, i.e. the fixed member 17 and the input terminal 4 are in the form of a single part.

The first and second tabs 18, 20 are symmetrical and meet at the level of a common base 21 which is connected to the common output terminal 5. Each of the first and second tabs 18, 20 comprises a convex section 22 and a concave section 23 in contact with the fixed member 17 when the system 1 is in the passive position.

According to a variant not shown and in accordance with the invention, the main branch 2 could comprise a single electrical contact, namely either the first electrical contact or the second electrical contact.

As shown in the embodiments in FIGS. 1 to 4, the system 1 comprises a first separator 13 and a second separator 14.

More specifically, as illustrated in FIGS. 2 to 4, the first and second separators 13, 14 are parallel, movable in translation and secured to the piston 9a, 9b.

When the system 1 is in the passive position (FIGS. 2 and 4), the separators 13, 14 are at a distance from the first and second electrical contacts 16, 19.

When the system 1 is in the active position (not shown), the first separator 13 is configured to be interposed between the fixed member 17 and the first flexible tab 18, and the second separator 14 is configured to be interposed between the fixed member 17 and the second flexible tab 20, so as to open the first and second electrical contacts 16, 19 and consequently the main branch 2.

The first and second separators 13, 14 are each in the form of a blade, the separators 13, 14 having equivalent dimensional characteristics.

Advantageously, the first and second separators 13, 14 each have a chamfer 24 configured to facilitate the opening of the first and second electrical contacts 16, 19.

More specifically, as illustrated in FIGS. 2 and 4, each chamfer 24 is external so that the inclined plane of the chamfer 24 is substantially parallel to the free end of the concave section 23 of the corresponding tab 18, 20.

The first and second separators 13, 14 are arranged on either side of the fixed member 17, each of the first and second separators 13, 14 being guided in translation between the fixed member 17 and the structure 12 of the system 1.

In the embodiments shown in FIGS. 1 to 4, the secondary branch 3 comprises in particular the fuse 6, the slide 10 and a stop 25 (from the input terminal to the output terminal).

As indicated above, the fuse 6 is sized to withstand the high intensity currents for a sufficiently long time, and is configured to interrupt a potential electric arc formed when it breaks.

More specifically, the fuse 6 is located in an insulating, watertight enclosure 26 in the structure 12. The fuse 6 takes the form of a metal strip perforated at regular intervals (in this case 9 perforations). The fuse 6 has a first end attached to the slide 10 via a screw 27 and a second end attached to the input terminal 4 via a screw 28.

The slide 10 is mounted so that it can move in translation in a housing 29 in the structure 12. The slide 10 is in the form of a shoulder axle, with the shoulder permanently located in the housing 29. The slide 10 has a first end attached to the fuse 6 via the screw 27 and a second end attached to a blind hole 30 in the stop 25 via a screw 31.

The stop 25 is L-shaped in cross-section and comprises a vertical portion 32 attached to the slide 10 and a horizontal portion 33. The stop 25 comprises a horizontal slot 34, the bottom of which forms a bearing face 35, which in this case is vertical.

When the system 1 moves from its passive position (FIG. 3) to its active position, the first separator 13 is able to come to bear against the bearing face 35 of the stop 25 to drive it in translation, and thus drive the slide 10 in translation so as to mechanically stress the fuse 6 in traction. The first separator 13 is at a distance from the bearing face 35 of the stop 25 when the system 1 is in the passive position. This predetermined distance allows the fuse 6 to be thermally stressed before it is mechanically stressed, making it easier to break.

The stop 25 is electrically connected to the output terminal 5 via a braid 36, the braid 36 having one end attached to the horizontal portion 33 of the stop 25 via a screw 37 (see FIG. 3).

In the first embodiment illustrated in FIGS. 1 to 3, the system 1 comprises an actuator 7a in a “retractor” configuration.

Such an actuator 7a comprises a body 38a fitted to the structure 12, a piston 9a movable in translation in a chamber 39a of the body 38a and a gas generator 8a arranged in the body 38a and connected to the chamber 39a.

On request from the control device, when a short-circuit current is detected, the pyrotechnic actuator 7a is triggered (or ignited), so that the piston 9a is placed in its final position under the action of the gas generated by the generator 8a, and thus drives the separators 13, 14 and the slide 10 (via the separators and the stop).

More specifically, the gas generator 8a comprises a pyrotechnic charge (or cartridge) (e.g. propellant in the form of pellets) and a device for igniting (or priming) the pyrotechnic charge, the gas generated by combustion of the pyrotechnic charge being used to move the piston 9a into its final position. The gas generator 8a is placed in an upper cavity 40 of the chamber 39a. The gas generated can be released directly into the chamber 39a or only when a threshold is reached (e.g. a pressure threshold).

The piston 9a is secured to the first and second separators 13, 14 via a connecting element 41a (or separator holder) made of electrically insulating material (e.g. plastic).

The piston 9a, the first and second separators 13, 14, the stop 25 and the slide 10 are movable in translation in the same direction (symbolised by arrow 42 in FIGS. 1 to 3) when the system 1 moves from a passive position to an active position.

The actuator 7a also comprises a locking device (for example a pin not shown) to lock the piston 9a in its end position and a damping device 43 (a damper with a honeycomb structure) to damp the piston 9a at the end of its stroke.

In the second embodiment shown in FIG. 4, the system 1 comprises an actuator 7b in a configuration referred to as “pusher” configuration.

The elements common to the first and second embodiments retain the same numerical references.

Such an actuator 7b comprises a body 38b fitted to the structure 12, a piston 9b which is movable in translation in a chamber 39b of the body 38b, a rod 44 secured to the piston 9b and a gas generator 8b located in the body 38b and connected to the chamber 39b.

On request from the control device, when a short-circuit current is detected, the pyrotechnic actuator 7b is triggered (or ignited), so that the piston 9b is placed in its final position under the action of the gas generated by the generator 8b, and thus drives the separators 13, 14 (via the lever) and the slide 10 (via the separators and the stop).

More specifically, the gas generator 8b comprises a pyrotechnic charge (or cartridge) (e.g. propellant in the form of pellets) and a device for igniting (or priming) the pyrotechnic charge, the gas generated by the combustion of the pyrotechnic charge being used to move the piston 9b into its final position. The gas generator 8b is placed at the bottom of the chamber 39b. The gas generated can be released directly into the chamber 39b or only when a threshold is reached (e.g. a pressure threshold).

The first and second separators 13, 14 are secured to the piston 9b via a lever 45 (or rocker arm) articulated in relation to the structure 12 of the system 1. More precisely, the rod 44 of the actuator 7b has a first end attached to the piston 9b and a second end carrying a first pin 46 inserted in a first oblong hole 47 of the lever 45. The system 1 also comprises a connecting element 41b (or separator holder) made of an electrically insulating material (e.g. plastic). The connecting element 41b has a first end secured to the first and second separators 13, 14 and a second end carrying a second pin 48 inserted in a second oblong hole 49 in the lever 45. The lever 45 is articulated at its center, i.e. between the first and second oblong holes 47, 49, about a substantially horizontal axis of rotation. The first and second oblong holes 47, 49 extend radially with respect to the axis of rotation of the lever 45.

The first and second separators 13, 14 are movable in translation in a first direction of movement (symbolised by arrow 50 in FIG. 4) which is opposite to a second direction of movement of the piston 9b (symbolised by arrow 51 in FIG. 4), when the system 1 moves from a passive position to an active position. The stop 25 and the slide 10 are movable in translation in the first direction of movement when the system 1 moves from a passive position to an active position.

The actuator 7b also comprises a damping device 52, 53 (progressive immobilisation of the tapered portion 52 of the rod in the tapered portion 53 of the body 38b) to damp the piston 9b at the end of its stroke.

Compared with the first embodiment (FIGS. 1 to 3), the second embodiment has the advantage of being lighter and more compact.

1. A system for protecting against a short-circuit for a high-voltage direct-current electrical circuit, the system comprising a main branch and a secondary branch connected in parallel and adapted to be connected to the electrical circuit via two common input and output terminals the secondary branch comprising a fuse and having an impedance greater than that of the main branch the system comprising a pyrotechnic actuator comprising a gas generator and a piston movable between an initial position and a final position, said system being configured to occupy the following positions:
a passive position in which the piston is in its initial position, the main and secondary branches being closed;
an active position in which the piston is placed in its final position under the action of gas generated by said generator when a short-circuit current is detected, the main branch being opened under the action of the piston;
the secondary branch comprising a movable slide which is secured to one end of the fuse and able to be driven in translation under the action of the piston when the system moves from its passive position to its active position, the system being configured so that the slide causes the fuse to break after the main branch has opened when the system moves from its passive position to its active position, so as to ensure that the secondary branch opens regardless of the intensity of the short-circuit current;
wherein the main branch comprises a first electrical contact between a fixed member and a first flexible tab, the system comprising a first separator which is movable in translation and secured to the piston the first separator being configured to be interposed between the fixed member and the first flexible tab when the system is in its active position, so as to open the first electrical contact and consequently the main branch.

2. The system according to claim 1, wherein the slide has a first end attached to the fuse and a second end attached to a stop which is movable in translation, the first separator being able to come to bear against a bearing face of the stop in order to drive it in translation when the system passes from its passive position to its active position.

3. The system according to claim 2, wherein the first separator is at a distance from the bearing face of the stop when the system is in the passive position.

4. The system according to claim 1, wherein the main branch comprises a second electrical contact between the fixed member and a second flexible tab, the system comprising a second separator which is movable in translation and secured both to the piston and to the first separator, the second separator being parallel to the first separator, the second separator being configured to be interposed between the fixed member and the second flexible tab when the system is in its active position, so as to open the first and second electrical contacts and consequently the main branch.

5. The system according to claim 4, wherein the fixed member is interposed between the first and second separators on the one hand and between the first and second tabs on the other hand, the first and second tabs being respectively in contact with the upper face and the lower face of the fixed member when the system is in the passive position.

6. The system according to claim 4, wherein the first and second separators each have a chamfer configured to facilitate the opening of the first and second electrical contacts.

7. The system according to claim 4, wherein the first and second tabs are symmetrical and meet at the level of a common base which is connected to the common output terminal each of the first and second tabs comprising a convex section and a concave section in contact with the fixed member when the system is in the passive position.

8. The system according to claim 4, wherein each of the first and second separators is guided in translation between a structure of the system and the fixed member

9. The system according to claim 4, wherein the main and secondary branches are horizontally next to each other, the actuator being vertically above the first and second separators and the main branch.

10. The system according to claim 4, wherein the first and second separators are secured to the piston via a connecting element the first and second separators and the piston being movable in translation in the same direction of movement when the system passes from a passive position to an active position.

11. The system according to claim 4, wherein the first and second separators are secured to the piston via a lever articulated with respect to a structure of the system the first and second separators being movable in translation in a direction of movement which is opposite to that of the piston when the system passes from a passive position to an active position.

12. The system according to claim 11, wherein the actuator comprises a rod having a first end attached to the piston and a second end carrying a first pin inserted in a first oblong hole of the lever the system comprising a connecting element having a first end secured to the first and second separators and a second end carrying a second pin inserted in a second oblong hole of the lever the lever being articulated between the first and second oblong holes

13. An electrical circuit comprising at least one electrical thruster and a system for protecting against a short-circuit according to claim 1.

14. An aircraft comprising an electrical circuit as claimed in claim 13.
